(19) United States
(12) Patent Application Publication
(10) Pub. No.: US 2013/0151062 A1
(43) Pub. Date: Jun. 13, 2013

(54) APPARATUS AND METHOD FOR ESTABLISHING ROUTE OF MOVING OBJECT

(71) Applicant: Electronics and Telecommunications Research Institute, Daejeon (KR)

(72) Inventors: YU-CHEOL LEE, Daejeon (KR); Myung Chan ROH, Daejeon (KR); Jaemin BYUN, Daejeon (KR); Ki In NA, Daejeon (KR); Sung Hoon KIM, Daejeon (KR)

(73) Assignee: Electronics and Telecommunications Research Institute, Daejeon (KR)

(21) Appl. No.: 13/709,538

(22) Filed: Dec. 10, 2012

(30) Foreign Application Priority Data
Dec. 9, 2011 (KR) 10-2011-0131849

(51) Int. Cl. G05D 1/02

(52) U.S. Cl. CPC G05D 1/0212
USPC 701/26

(57) ABSTRACT

An apparatus for establishing a route of a moving object, the apparatus including: an information reception unit configured to receive map data from the outside, a global route generation unit configured to generate a global route based on the map data and location information and destination information of a moving object, a surrounding environment sensor unit configured to sense information regarding a surrounding environment of the moving object when the moving object runs, a local route generation unit configured to generate one or more local routes based on the sensed information regarding a surrounding environment, a running unit configured to run the moving object based on the local route, and, when two or more local routes are generated, establish a route of the moving object through matching between the global route and the local routes, and running the moving object.

### RELATED APPLICATIONS(S)

This application claims the benefit of Korean Patent Application No. 10-2011-0131849, filed on Dec. 9, 2011, which is hereby incorporated by references as if fully set forth herein.

### FIELD OF THE INVENTION

The present invention relates to establishing a route of a moving object, and more particularly, to an apparatus and method for allowing a moving object such as an outdoor robot or an unmanned ground vehicle to generate an adaptable route in any environment.

### BACKGROUND OF THE INVENTION

As a robot technology has been developed, user demand for autonomous traveling of an outdoor robot and an unmanned ground vehicle has been increased. The autonomous traveling technology of an outdoor robot and an unmanned traveling technique may be roughly divided into location recognition, mapping, and a routing plan. Among them, a location recognition and mapping technique have been researched by many researchers and developers, and as various sensors have been developed, the technology has been gradually matured. In particular, in case of mapping, mapping is precisely obtained through various types of geographic information system (GIS) information such as Google map and the like. Also, in case of location recognition technology, the use of high-priced light intensity detection and ranging LIDAR, real time kinematic-differential global positioning system (RTK-DGPS), information network system (INS), and the like can more accurately estimate a location of a robot and an unmanned ground vehicle.

However, no matter how high-priced location recognition sensor is, it inevitably has much error in places shadowed by skyscrapers, roadside trees, and the like. Here, if a robust route is not planned, the robot and the unmanned ground vehicle may be damaged and, in addition, a user may get seriously hurt. Thus, there is a need for a method for establishing a route ensuring stable traveling when precise mapping information is obtained through GIS information or the like, although a location of the robot or the unmanned ground vehicle is not accurate.

### SUMMARY OF THE INVENTION

In view of the above, therefore, the present invention provides an apparatus and method which are capable of generating a stable route of a moving object by using GIS information and sensor information although a location of the moving object is not accurate in autonomously traveling in an outdoor area.

The objects of the invention are not limited to the foregoing objects, but other objects that are not described above will be apparently understood by those skilled in the art from the following description.

In accordance with an aspect of the present invention, there is provided an apparatus for establishing a route of a moving object, the apparatus including: an information reception unit configured to receive map data from the outside, a global route generation unit configured to generate a global route based on the map data and location information and destination information of a moving object, a surrounding environment sensor unit configured to sense information regarding a surrounding environment of the moving object when the moving object runs, a local route generation unit configured to generate one or more local routes based on the sensed information regarding a surrounding environment, a running unit configured to run the moving object based on the local route, and, when two or more local routes are generated, establish a route of the moving object through matching between the global route and the local routes, and running the moving object.

The local route generation unit generates a local route for avoiding an obstacle based on the sensed information regarding the surrounding environment.

The surrounding environment sensor unit is a laser scanner or an image recognition sensor for recognizing an obstacle or environment characteristics near or around the moving object.

When two or more local routes are generated, the running unit selects any one of the generated local routes based on the global route to run the moving object, or runs the moving object based on the global route.

In accordance with another aspect of the present invention, there is provided a method for establishing a route of a moving object, the method including: generating a global route based on pre-stored map data and location information and destination information of a moving object, sensing information regarding a surrounding environment of the moving object while the moving object is running, generating one or more local routes based on the sensed information regarding a surrounding environment, when two or more local routes are generated, selecting one of the generated local routes based on the local route and running the moving object, when a single local route is generated, running the moving object by using the generated local route.

The sensing information regarding a surrounding environment includes sensing information regarding a surrounding environment of the moving object by using a laser scanner or an image recognition sensor for recognizing an obstacle or environment characteristics near or around the moving object.

### BRIEF DESCRIPTION OF THE DRAWINGS

The above and other objects and features of the present invention will become apparent from the following description of preferred embodiments, given in conjunction with the accompanying drawings, in which:

FIG. 1 is a block diagram showing an apparatus for establishing a route of a moving object in accordance with an embodiment of the present invention;

FIG. 2 is an exemplary view of a topological map based on GIS information generated in an embodiment of the present invention;

FIG. 3 is an exemplary view of a local route for avoiding an obstacle generated in the embodiment of the present invention;

FIG. 4 is a view illustrating a process of selecting a route when there are two or more local routes in the embodiment of the present invention; and

FIG. 5 is a flow chart illustrating a process of establishing a route of a moving object in accordance with an embodiment of the present invention.

### DETAILED DESCRIPTION OF THE EMBODIMENT

Hereinafter, an apparatus and method for stably establishing a route of a moving object by using GIS information and information regarding a surrounding environment of a moving object sensed by a sensor loaded in the moving object in accordance with embodiments of the present invention will be described in detail with the accompanying drawings.

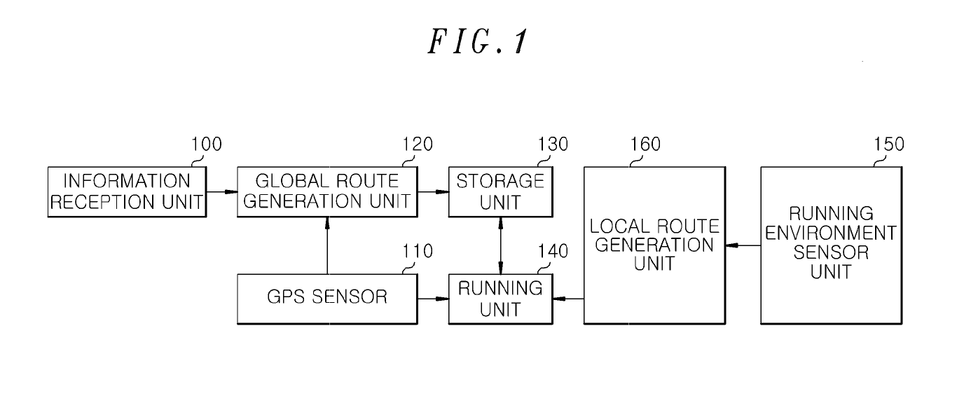

FIG. 1 is a block diagram showing an apparatus for establishing a route of a moving object in accordance with an embodiment of the present invention. The apparatus for establishing a route of a moving object may include an information reception unit 100, a GPS sensor 110, a global route generation unit 120, a storage unit 130, a running unit 140, a surrounding environment sensor unit 150, and a local route generation unit 160. In an embodiment of the present invention, the moving object may be a robot, an unmanned ground vehicle, or the like.

The information reception unit 100 receives GIS information such as Google map, or the like from the outside and provides the same to the global route generation unit 120. More specifically, the information reception unit 100 interworks with a wired/wireless communication network (not shown) so as to be connected to a server providing GIS information to receive the GIS information.

The GPS sensor 110 senses location information of the moving object and provides the same to the global route generation unit 120 and the running unit 140.

As destination information of the moving object is input, the global route generation unit 120 generates a global route based on the current location information of the moving object, the destination information, and the GIS information provided from the GPS sensor 110, and stores the same in the storage unit 130.

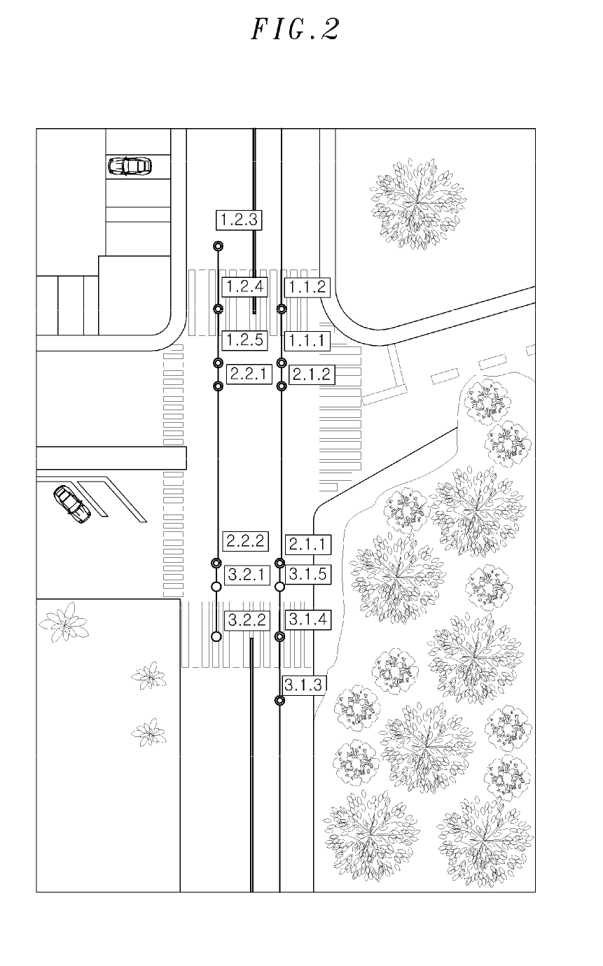

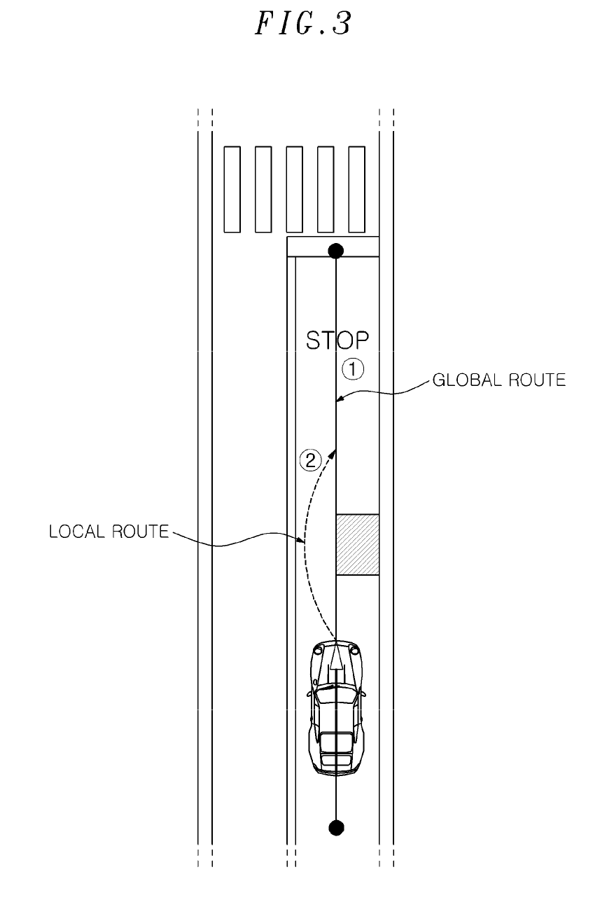

The global route generation unit 120 extracts a road network map (a topological map) appropriate for a running route of the moving object from the GIS information received through the information reception unit 100, and generates a global route by using the same. For example, as shown in FIG. 2, a road network map generated through Google map includes information regarding connections between major points on the road, and respective major point (node) information on the road network map may include characteristic information of the road including node location information, node connection information, lanes, a road width, and the like. A global route is generated by using the characteristic information. That is, when destination information is input, a global route as shown in FIG. 3 is generated based on the current location information of the moving object and the node connection information.

The local route generation unit 160 generates one or more local routes for avoiding an obstacle based on information regarding a surrounding environment of the moving object received from the surrounding environment sensor unit 150. The generated local routes are stored in the storage unit 130. More specifically, the local route generation unit 160 recognizes a location of an obstacle based on information provided from the surrounding environment sensor unit 150, and generate a local route as shown in FIG. 3 in order to avoid the obstacle. The running unit 140 runs the moving object based on the local route stored in the storage unit 130. When two or more local routes are generated, the running unit 140 establishes a route of the moving object by matching the global route and the local routes, and runs the moving object by using the established route.

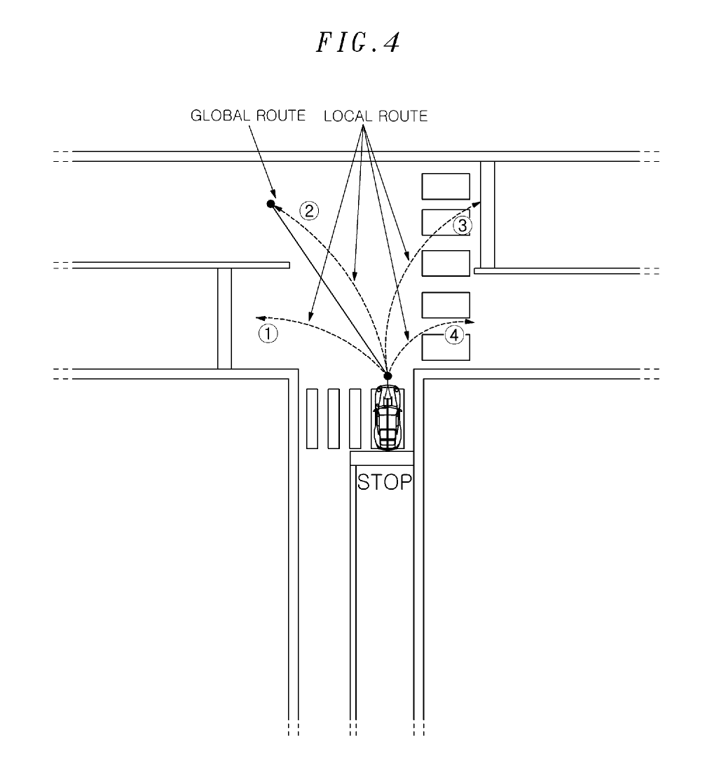

Meanwhile, while the moving object is running based on the local route, the running unit 140 re-establishes a route based on the number of local routes generated by the local route generation unit 160 and runs the moving object. For example, as illustrated in FIG. 3, when there is a single local route, the running unit 140 runs the moving object by avoiding an obstacle based on the local route \textcircled{2}. As illustrated in FIG. 4, when several local routes \textcircled{1}\textcircled{2}\textcircled{3}\textcircled{4} are generated, the running unit 140 matches the local routes \textcircled{1}\textcircled{2}\textcircled{3}\textcircled{4} to a global route to select a global route \textcircled{2} and run the moving object. For example, while the moving object runs, and as shown in FIG. 4, when the route is divided into several forks like an intersection or when two or more local routes are generated, the running unit 140 selects one of the local rouges generated by the local route generation unit 160 based on the global route, and runs the moving object.

When the moving object starts to run, the surrounding environment sensor unit 150 senses an obstacle and environment characteristics near or around the moving object. The sensed obstacle and environmental characteristics are provided to the local route generation unit 160. The surrounding environment sensor unit 150 may be, for example, a laser scanner, an image recognition sensor, or the like.

As described above, the global route and the local route are generated based on the GIS information and the current location information of the moving object provided from the GPS sensor 110, whereby a route for the moving object to strongly and stably run can be provided although the location information of the moving object is indefinite.

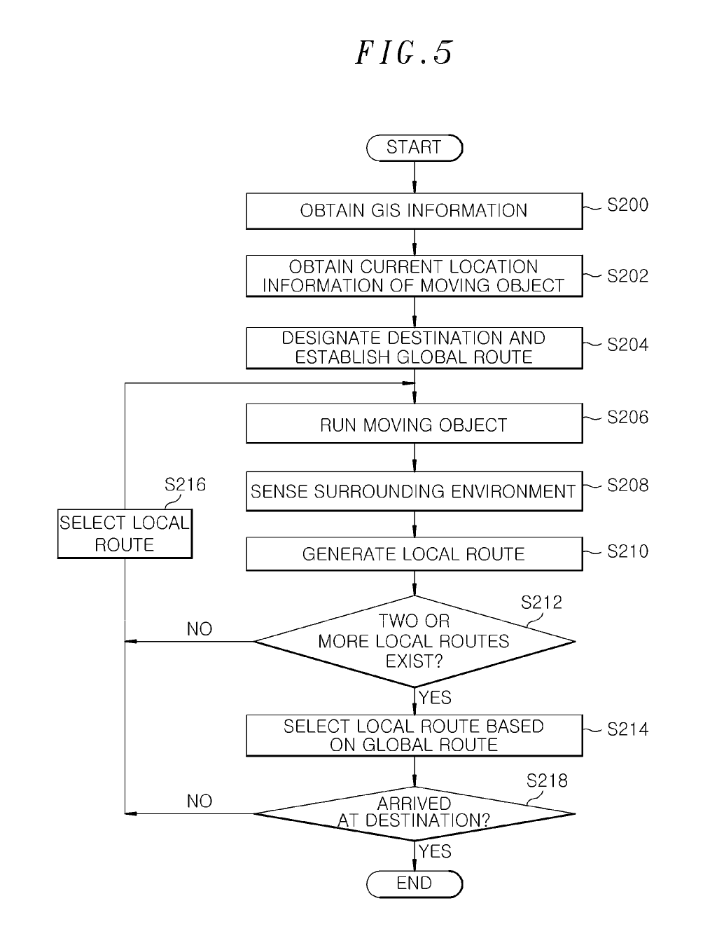

FIG. 5 is a flow chart illustrating a process of establishing a route of a moving object in accordance with an embodiment of the present invention.

As illustrated in FIG. 5, the global route generation unit 120 obtains GIS map information through the information reception unit 100 in step S200, and obtains current location information of the moving object through the GPS sensor 110 in step S202.

Thereafter, when a destination is designated, the global route generation unit 120 establishes a global route up to a destination based on the road network map obtained by using the GIS map information and the current location information of the moving object in step S204, and stores the same in the storage unit 130.

Then, the running unit 140 runs the moving object based on a local route generated in real time by the local route generation unit 160 in step S206.

As the moving object runs, the surrounding environment sensor unit 150 senses a surrounding environment of the moving object in step S208, and provides the sensed information to the local route generation unit 160. The local route generation unit 160 generates a local route based on the sensed information in step S210, and then stores the same in the storage unit 130.

Meanwhile, the running unit 140 determines whether or not two or more local routes have been generated through searching from the storage unit 130 in step S212.

When it is determined in step S212 that two or more local routes have been generated, the running unit 140 matches the local routes and the global route to select one local route in step S214, and then runs the moving object based on the selected local route.

On the other hand, when it is determined, in step S212, that only one local route has been generated, the running unit 140 selects a local route in step S216 and then runs the moving object.

In the state in which the moving object is running through such a route selection, the running unit 140 determines whether or not the moving object has reached a destination in step S218. When the moving object has reached a destination, the running unit 140 terminates a route establishing process.

As described above, in accordance with the embodiments of the present invention, when a current location of the moving object is determined, a global route for a destination is generated, and when the moving object is running, a location of an obstacle determined through sensing information measured by the surrounding environment sensor unit 150 is recognized to detect an optimum local route, thereby generating a route ensuring stable running of the moving object.

In addition, in accordance with the embodiment of the present invention, when two or more local routes are generated in an intersection or the like, a global route is used to select a route most appropriate for a destination, whereby a running route can be stably generated without using a high-priced location recognition sensor.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for establishing a route of a moving object, the apparatus comprising:
an information reception unit configured to receive map data from the outside;
a global route generation unit configured to generate a global route based on the map data and location information and destination information of a moving object;
a surrounding environment sensor unit configured to sense information regarding a surrounding environment of the moving object when the moving object runs;
a local route generation unit configured to generate one or more local routes based on the sensed information regarding a surrounding environment; and
a running unit configured to run the moving object based on the local route, and, when two or more local routes are generated, establish a route of the moving object through matching between the global route and the local routes, and running the moving object.

2. The apparatus of claim 1, wherein the local route generation unit generates a local route for avoiding an obstacle based on the sensed information regarding the surrounding environment.

3. The apparatus of claim 1, wherein the surrounding environment sensor unit is a laser scanner or an image recognition sensor for recognizing an obstacle or environment characteristics near or around the moving object.

4. The apparatus of claim 1, wherein when two or more local routes are generated, the running unit selects any one of the generated local routes based on the global route to run the moving object, or runs the moving object based on the global route.

5. A method for establishing a route of a moving object, the method comprising:
generating a global route based on pre-stored map data and location information and destination information of a moving object;
sensing information regarding a surrounding environment of the moving object while the moving object is running;
generating one or more local routes based on the sensed information regarding a surrounding environment;
when two or more local routes are generated, selecting one of the generated local routes based on the local route and running the moving object; and
when a single local route is generated, running the moving object by using the generated local route.

6. The method of claim 5, wherein said sensing information regarding a surrounding environment comprises sensing information regarding a surrounding environment of the moving object by using a laser scanner or an image recognition sensor for recognizing an obstacle or environment characteristics near or around the moving object.
